(19) United States
(12) Patent Application Publication
(10) Pub. No.: US 2023/0000068 A1
(43) Pub. Date: Jan. 5, 2023

(54) INSECT BARRIER BASE SYSTEM

(71) Applicant: Benjamin R. Warthen, Lehigh Acres, FL (US)

(72) Inventor: Benjamin R. Warthen, Lehigh Acres, FL (US)

(21) Appl. No.: 17/364,420

(22) Filed: Jun. 30, 2021

(51) Int. Cl. A01M 29/34; A01K 5/01; A47G 7/04; A01G 13/10

(52) U.S. Cl. CPC A01M 29/34; A01K 5/0142; A47G 7/041; A01G 13/105

(57) ABSTRACT

An insect barrier base system includes a base, at least one column defining a top column end and a bottom column end, the column further defining a periphery, wherein the bottom column end communicates with the base, insect-trapping material positioned around the periphery of the at least one column between the top column end and the bottom column end, and a tray communicating with the top column end, the tray configured to hold an item.

### CROSS-REFERENCE TO RELATED APPLICATIONS

This application is a continuation-in-part of application Ser. No. 17/126,177, filed on Dec. 18, 2020. The patent application identified above is incorporated herein by reference in its entirety to provide continuity of disclosure.

### BACKGROUND OF THE INVENTION

This disclosure relates to insect management devices. More particularly, this disclosure relates to devices for preventing insects from accessing food, water, and plants.

Insects are a nuisance and can even threaten animal health when they crawl into places that set aside food intended for animals such as pets. For example, roaches are known disease carriers. If they crawl into food intended for a dog or a cat, they can contaminate the food to such a degree as to cause illness in the animal that ingests the contaminated food. The affected dog or cat could, for instance, contract a stomach worm if it has eaten an infected roach.

Various devices have been implemented to prevent unwanted intrusion of insects into animal feed dishes. For example, U.S. Pat. No. 6,860,229 to Craft teaches what purports to be an ant-proof pet food bowl, comprised of a top food container and a bottom water container connected to one another by a central post. The bottom water container is at least partially filled with water so as to create a “moat” intended to prevent crawling insects from reaching the top food container. For further example, U.S. Pat. No. 4,802,302 to Alnafissa discloses a pet food dish comprised of a base section and a feed dish removably received in the base section. A band with an insect-trapping adhesive layer on its outer surface is placed around the periphery of a cylindrical side wall of the base section. The feed dish has a flanged side wall that prevents access to the band by the animal intended to be fed, once the feed dish sits in the base section. Additionally, a plurality of lugs extend radially outwardly from the base section side wall to function as a stop intended to prevent downward slippage of the band along the side wall.

While devices such as those mentioned above may have some effectiveness toward preventing unwanted insect intrusion into feeding dishes, they are subject to some drawbacks. For example, devices that rely upon creation of a “moat” in a lower bowl or container can fail if a quantity of the water evaporates sufficient to allow an insect to crawl on a portion of the inside surface of the lower bowl. Additionally, devices that require the use of adhesive-carrying strips may be require frequent replacement. Strips, by definition, have a small height, such that it may take only a relatively few number of insects to cover the adhesive strip to the point where its effectiveness becomes limited.

### SUMMARY OF THE INVENTION

It is to be understood that this summary is not an extensive overview of the disclosure. This summary is exemplary and not restrictive. The sole purpose of this summary is to explain and exemplify certain concepts of the disclosure as an introduction to the following complete and extensive detailed description.

In an aspect of the present disclosure, an insect barrier base system comprises a base, a column defining a top column end and a bottom column end, the column further defining a periphery, wherein the bottom column end communicates with the base, insect-trapping material positioned around the periphery of the column between the top column end and the bottom column end, and a tray communicating with the top column end, the tray configured to hold a perishable item. Optionally, the insect-trapping material is positioned around the column with a spool assembly comprising a hollow core disposed around the periphery of the column, and a supply of the insect-trapping material wound around the core, the spool assembly configured to permit selective removal of successive increments of the insect-trapping material from the core.

In another aspect of the present disclosure, a method of preventing insect intrusion upon a perishable item comprises the steps of placing the perishable item in a tray, the tray communicating with a top column end of a column that communicates at a column bottom end with a base, and causing an insect to be trapped at a position above the base but before it reaches the tray.

Various implementations described in the present disclosure can comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations can be realized and obtained by means of the systems, methods, features particularly pointed out in the appended claims. These and other features will become more fully apparent from the following description and appended claims, or can be learned by the practice of such exemplary implementations as set forth hereinafter.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a perspective view of an insect barrier base system constructed according to an aspect of the present disclosure, showing a dog eating food held by a tray of the system.

FIG. 2 is a perspective view of the insect barrier base system of FIG. 1 being used to hold water in its tray, for drinking by an animal such as the dog shown.

FIG. 3 is a perspective view isolating the insect barrier base system of FIG. 1.

FIG. 4 is a top view of the insect barrier base system of FIG. 1.

FIG. 5 is a bottom view of the insect barrier base system of FIG. 1.

FIG. 6 is a side view of an insect barrier base system constructed according to another aspect of the present disclosure.

FIG. 7 is a sectional view of the column and spool assembly in the insect barrier base system taken along line 7-7 of FIG. 6.

FIG. 8 is an exploded view of the insect barrier base system of FIG. 6.

FIG. 9 is an exploded view of an insect barrier base system constructed according to yet another aspect of the present disclosure, wherein a peripheral shield extends downwardly from the tray.

FIG. 10 is a perspective view of the insect barrier base system of FIG. 1 being used to hold a plant in its tray.

FIG. 11 is a perspective view of the insect barrier base system of FIG. 1 being used indoors to hold a toaster in its tray, for the purpose of preventing insect intrusion upon bread product remnants collected at the bottom of the toaster.

FIG. 12 is a perspective view of the insect barrier base system of FIG. 1 having multiple tray-holding columns being used to hold a large planter in its tray.

### DETAILED DESCRIPTION

Although conventional devices of the types described in the foregoing Background section may be generally suitable to achieve their intended purposes, an insect barrier base system that overcomes the noted drawbacks of such devices, and that exhibits enhanced effectiveness at preventing unwanted insect intrusion into feed bowls and other designated containers, has proven to be desirable.

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, and, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Reference numerals common to more than one accompanying figure identify the same component throughout the figures.

As used throughout, the singular forms “a,” “an” and “the” include plural referents unless the context clearly dictates otherwise. Thus, for example, reference to a quantity of one of a particular element can comprise two or more such elements unless the context indicates otherwise.

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the present disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list.

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

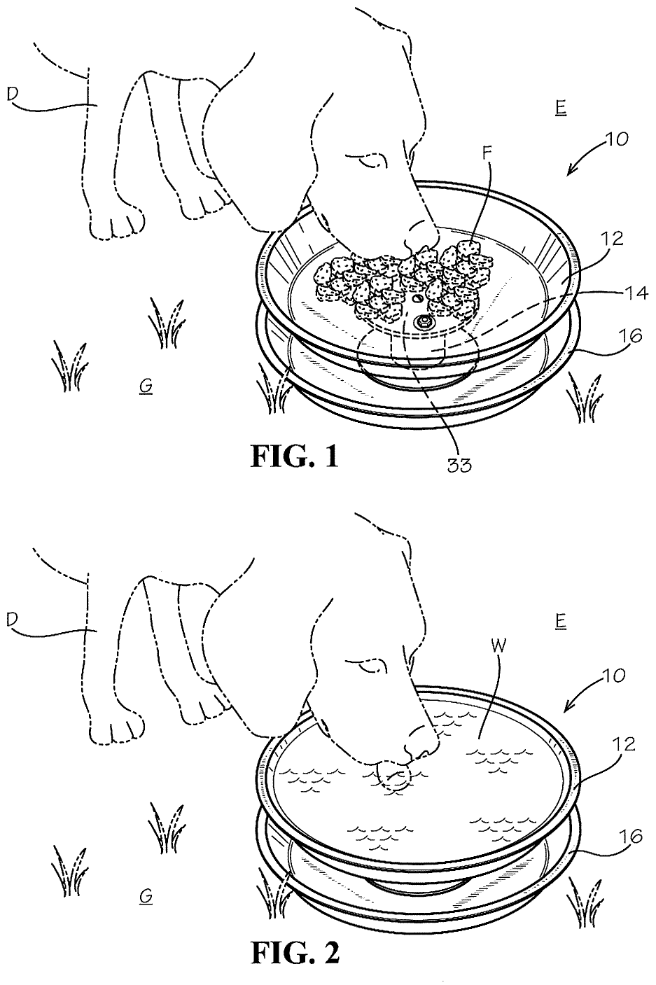

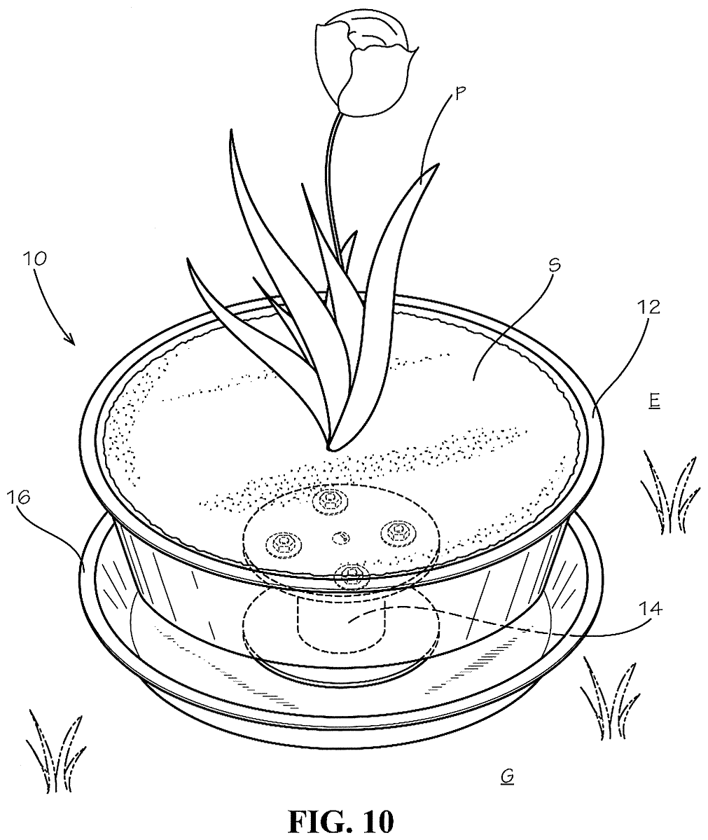

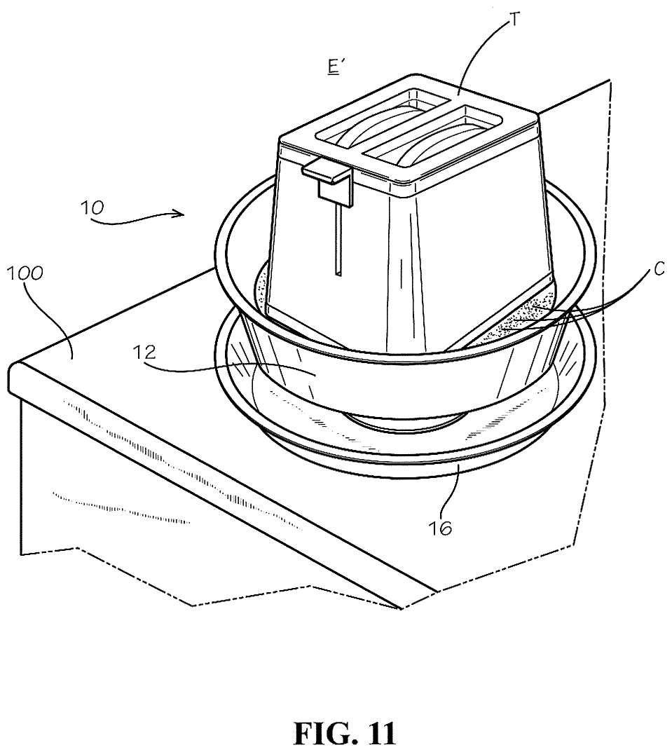

FIGS. 1 and 2 illustrate examples of use of an insect barrier base system 10 constructed in accordance with an aspect of the present disclosure. System 10 is shown in an ambient environment E and resting on outdoor ground G, where a tray 12 of system 10 is configured to hold, above the ground G, a perishable item intended for consumption by an animal such as a dog D. As used herein, the term “perishable item” encompasses not only consumables, but also: (i) plants, as discussed in greater detail with regard to FIG. 10; and (ii) remnants of consumables, as discussed in greater detail with regard to FIG. 11. The term “consumables” means substances that are intended to be consumed, including both food (item “F” in FIG. 1) and water (item “W” in FIG. 2). FIG. 1 further illustrates a column 14 supporting the tray 12 and communicating at its bottom end with a base 16 resting on the ground G.

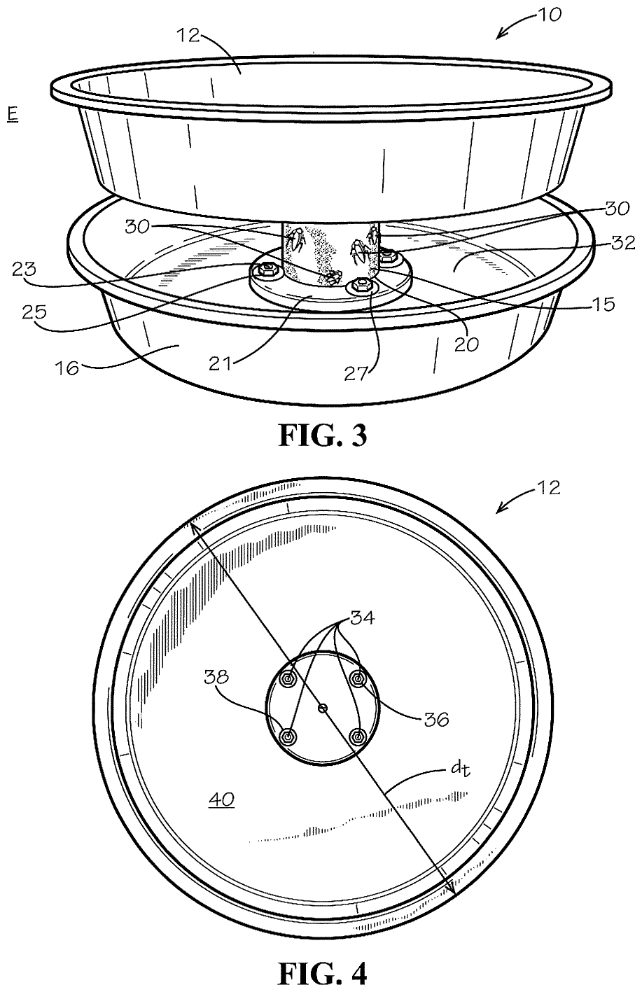

FIG. 3 is a perspective view isolating the insect barrier base system of FIG. 1. In this embodiment, insect-trapping material 15 contacts the periphery of the column 14. The insect-trapping material 15 depicted as having trapped a plurality of cockroaches 30 as an example of effectiveness against various crawling insects, preferably comprises double-sided tape with a coatings of an insect-killing compound on both sides of the paper. The insect-killing compound preferably possesses sufficient stickiness (tackiness) to stop cockroaches such as at 30 in their tracks once they reach the material 15.

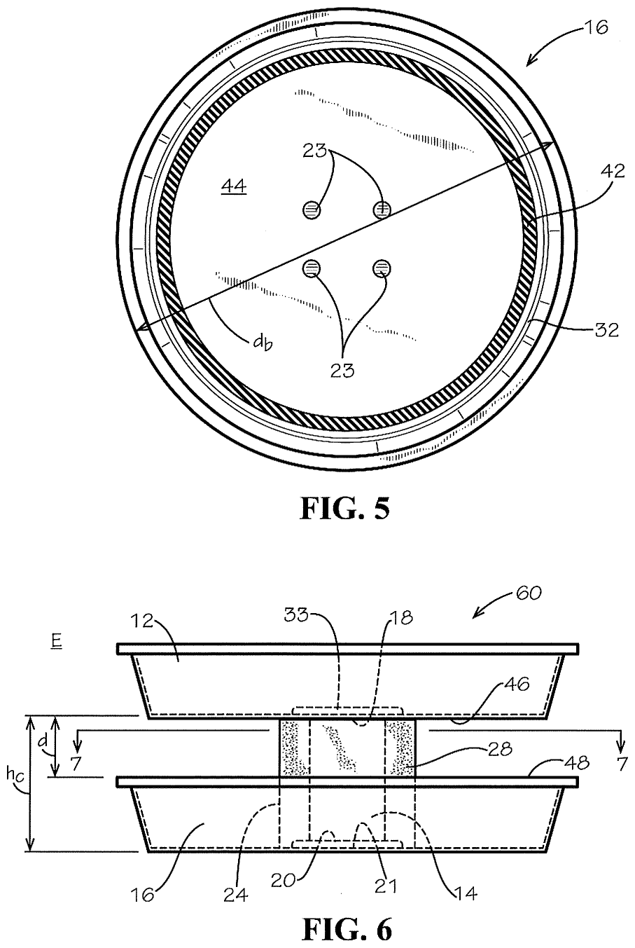

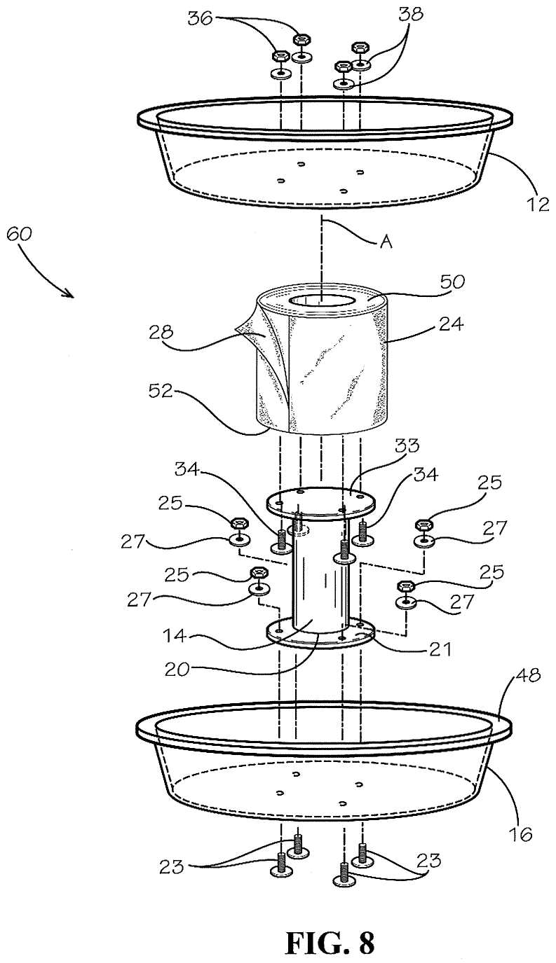

Referring to FIGS. 3-5, a lower annular flange 21 is connected to the bottom column end 20 of the column 14 by screws, such that, preferably, the lower annular flange 21 and the column 14 are concentrically aligned about central axis A (FIG. 8). A set of lower fasteners, such as lower bolts 23 (see also FIG. 5) cooperating with nuts 25 and optionally washers 27, attach the lower annular flange 21 to a base bottom 32 of the base 16, thereby bringing the column 14 into rigid communication with the base 16. Similarly, an upper annular flange 33 (FIG. 1) is connected to a top column end 18 (FIG. 6) of the column 14, in the same manner in which lower annular flange 21 is connected to the bottom column end 20. A set of upper fasteners, such as upper bolts 34 (FIG. 4) cooperating with nuts 36 and optionally washers 38, attach the upper annular flange 33 to a tray bottom 40 of the tray 12, thereby bringing the column 14 into rigid communication with the tray 12.

Referring to both FIGS. 4 and 5, the base 16 and the tray 12 preferably each define a circular shape, the tray 12 defining a tray diameter dₜ and the base 16 defining a base diameter d_{b}. Preferably, the base diameter d_{b} and the tray diameter dₜ are substantially equal. This helps to prevent the base 16 from catching any food or water that may be pushed out of the tray 12 by the feeding animal. If the shape of the tray 12 is circular as shown, the tray diameter dₜ can be sufficiently large to thwart access by a feeding animal of the insect trapping material 28 on the spool assembly 24.

FIG. 5 additionally shows an optional non-slip footing 42 that can be attached in any suitable manner, such as adhesively, to a bottom surface 44 of the base bottom 32. Non-slip footing 42 can be used to enhance functionality of the insect barrier base systems of the present disclosure for indoor use, exemplified with regard to FIG. 11, discussed later herein. Non-slip footing is preferably constructed of rubber to resist slippage of the insect barrier base system when supported on an indoor surface. Although FIG. 5 depicts footing 42 as a continuous ring, footing 42 may instead comprise a plurality of discontinuous non-slip pads spaced from one another and distributed across the bottom surface 44 in any suitable pattern.

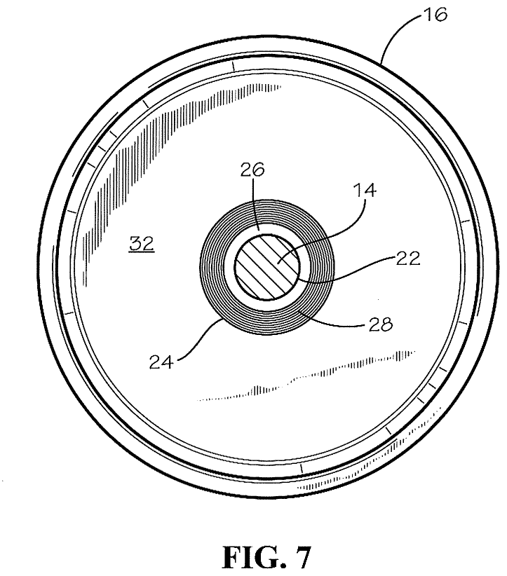

FIGS. 6-8 illustrate an insect barrier base system 60 constructed in accordance with another aspect of the present disclosure. System 60 may be constructed identically as system 10, except that a spool assembly 24 substitutes for the insect trapping material 15 (FIG. 3) used by itself in system 10. The spool assembly 24 is intended to provide for a more convenient means of replenishing a supply of insect trapping material once it has been completely spent. As discussed above, the column 14 defines a top column end 18 and a bottom column end 20 communicating with the base 16. The column 14 further defines a periphery 22 (FIG. 7). The spool assembly 24 is positioned around the periphery 22 of the column 14 between the top column end 18 and the bottom column end 20. The spool assembly 24 comprises a hollow core 26 (FIG. 7) positioned around, and preferably contacting, the periphery 22 of the column 14, and further comprises a supply of insect-trapping material 28 wound around the hollow core 26. The spool assembly 24 is configured to permit selective removal of successive increments of the insect-trapping material 28 from the core 26. Specifically, once an increment of material 28 that is exposed to the ambient outdoor environment E traps a number of insects 30 that, in the judgment of a user of the system 10, diminishes its continued effectiveness to trap additional insects, the user can peel off the exposed increment from the spool assembly 24 to reveal a new, successive increment of the insect-trapping material 28 that now becomes the increment exposed to the outdoor environment E. The insect-trapping material 28 may have the same characteristics as the insect-trapping material 15 discussed above with regard to FIG. 3.

As best seen in FIG. 6, the tray 12 defines a tray bottom surface 46, the base 16 defines an upper base edge 48, and the column 14 further defines a column height h_{c}, which separates the tray bottom surface 46 from the upper base edge 48 by a distance d that is sufficiently small to prevent a feeding animal from accessing the insect-trapping material 28 on the spool assembly 24. Yet the distance d is also sufficiently large to prevent an insect 30 from bridging the tray bottom surface 46 and the upper base edge 48. Preferably, the distance d ranges from and including 1.5 inches to and including 1.75 inches.

As seen from the exploded view of FIG. 8, the spool assembly 24 is disposed between the upper flange 33 and the lower flange 21. Preferably, in such an arrangement, the axial height of the insect-trapping material 28 is coextensive with the height h_{c} (FIG. 6) of the column 14. This ensures that an upper end 50 of the material 28 will abut a lower surface of the upper flange 33, and that a lower end 52 of the material 28 will abut against an upper surface of the lower flange 21. With such an arrangement, crawling insects 30 entering the base 16 will not be able to contact any part of the column 14 when attempting to climb the system 60, because any such attempt will instead result in the insects 30 contacting the insect-trapping material 28. Such an embodiment thus causes an insect 30 to be trapped at a position above the base 16 but before it reaches the tray 12. Alternatively, though not shown, the spool assembly 24 may peripherally surround both the upper flange 33 and the lower flange 21, though such a relative sizing may bring the hollow core 26 out of the direct engagement with the periphery 22 of column 14 that is illustrated in FIG. 7.

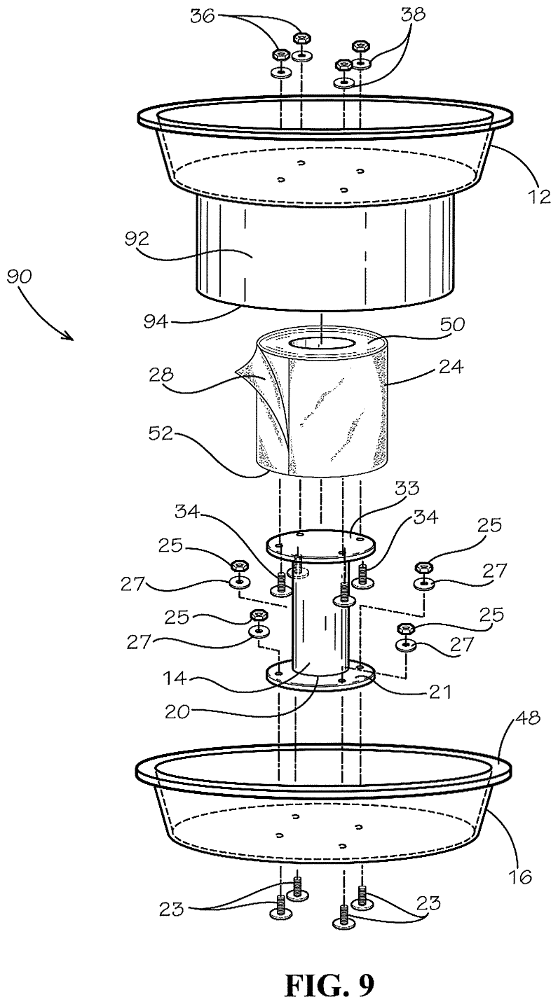

FIG. 9 is an exploded view of an insect barrier base system 90 constructed according to yet another aspect of the present disclosure, wherein a peripheral shield 92 extends downwardly from the tray 12. System 90 may be otherwise constructed identically to the system 60 of FIGS. 6-8. The peripheral shield 92 functions as an additional barrier to prevent access to the insect-trapping material 28 by a feeding animal. The peripheral shield 92 defines a bottom shield edge 94. Once system 90 is fully assembled, the bottom shield edge 94 and the upper base edge 48 may be separated from one another by a distance that is sufficiently small to prevent a feeding animal from accessing the insect-trapping material 28 on the spool assembly 24, yet also sufficiently large to prevent an insect 30 from bridging the bottom shield edge 94 and the upper base edge 48. Such a distance preferably ranges from and including 1.25 inches to and including 1.5 inches.

FIG. 10 shows an alternative use of the insect barrier base system 10 (FIGS. 1-5) to protect plants (such as the plant P shown), rather than consumables such as food or water. Certain types of crawling insects are known to harm and eat plants. For example, aphids suck out plant sap, and the affected plant can die without treatment. As further examples, cutworms and slugs also feed on plants. To protect plant P, the tray 12 can hold soil S in which the plant P is planted. Though shown in an outdoor ambient environment E and resting on the ground G, it is understood that the system 10 could also be used indoors to protect indoor plants. Furthermore, although FIG. 10 depicts plant P being supported by system 10, it is understood that plant P could also be supported in like manner by systems 60 (FIGS. 6-8) and 90 (FIG. 9).

FIG. 11 shows yet another alternative use of the insect barrier base system 10, here situated in an indoor ambient environment E′ and resting upon a countertop 100. The perishable items protected from insects with this use of the system 10 is a collection of remnants of a bread product, such as bread crumbs C collected at a bottom of a toaster T. The toaster T can be positioned within the tray 12 as shown. Although FIG. 11 depicts toaster T being supported by system 10, it is understood that toaster T could also be supported in like manner by systems 60 (FIGS. 6-8) and 90 (FIG. 9).

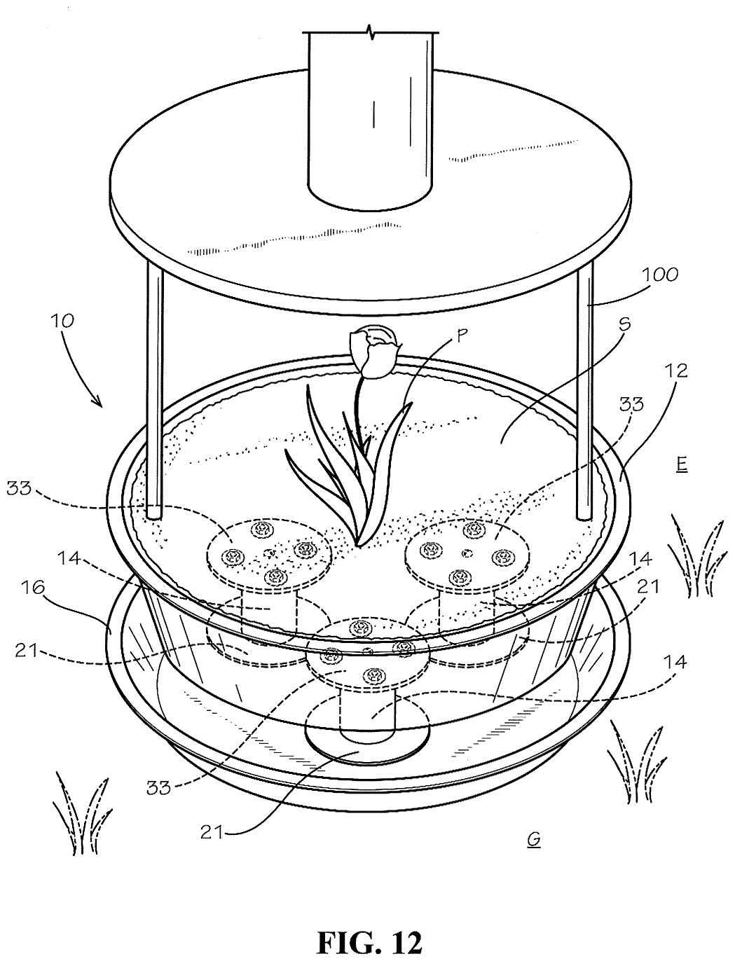

FIG. 12 shows a variation of the insect base barrier 10 having multiple columns 14 being employed to support a large object, such as a planter 100 as shown. Having multiple columns would provide better balance and increased weight bearing capability for the insect base barrier of the present system.

Although several aspects have been disclosed in the foregoing specification, it is understood by those skilled in the art that many modifications and other aspects will come to mind to which this disclosure pertains, having the benefit of the teaching presented in the foregoing description and associated drawings. For example, although the tray 12 and the base 16 have been shown herein assuming circular shapes, other shapes are contemplated as being within the scope of the present disclosure. Likewise, although the shapes of the column 14 and the spool assembly 24 are shown as being generally cylindrical, other shapes are contemplated as being within the scope of the present disclosure. Still further, other attachment hardware may be used to facilitate either partial or complete disassembly of the system 10 when the spool assembly 24 is completely spent and needs to be replaced. It is thus understood that the disclosure is not limited to the specific aspects disclosed hereinabove, and that many modifications and other aspects are intended to be included within the scope of any claims that can recite the disclosed subject matter.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications can be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An insect barrier base system, comprising:
a base;
at least one column defining a top column end and a bottom column end, the column further defining a periphery, wherein the bottom column end communicates with the base;
insect-trapping material positioned around the periphery of the at least one column between the top column end and the bottom column end; and
a tray communicating with the top column end, the tray configured to hold an item.

2. The insect barrier base system of claim 1, wherein the insect-trapping material contacts the periphery of the at least one column.

3. The insect barrier base system of claim 1, wherein the insect-trapping material is wound upon a hollow core positioned around the periphery of the at least one column, the hollow core and the insect-trapping material comprising a spool assembly configured to permit selective removal of successive increments of the insect-trapping material from the core.

4. The insect barrier base system of claim 1,
wherein both the base and the tray define a circular shape, the base defining a base diameter and the tray defining a tray diameter;
wherein the base diameter and the tray diameter are substantially equal.

5. The insect barrier base system of claim 1,
wherein the tray defines a circular shape, the tray defining a tray diameter; and
wherein the tray diameter is sufficiently large to thwart access by a feeding animal of the insect trapping material.

6. The insect barrier base system of claim 5, wherein the tray diameter ranges from and including 1.25 inches to and including 1.5 inches.

7. The insect barrier base system of claim 1,
wherein the at least one column further defines a column height;
wherein the tray defines a tray bottom surface;
wherein the base defines an upper base edge;
wherein the column height separates the tray bottom surface and the upper base edge by a distance that is sufficiently small to the spool assembly; and
wherein the distance is also sufficiently large to prevent an insect from bridging the tray bottom surface and the upper base edge.

8. The insect barrier base system of claim 7, wherein the distance ranges from and including 1.25 inches to and including 1.5 inches.

9. The insect barrier base system of claim 1,
further comprising an upper flange connected to the top column end and a lower flange connected to the bottom column end;
wherein the upper flange is connected to the tray and the lower flange is connected to the base.

10. The insect barrier base system of claim 9, wherein the insect-trapping material is disposed between the upper flange and the lower flange.

11. The insect barrier base system of claim 9, wherein the insect-trapping material peripherally surrounds both the upper flange and the lower flange.

12. The insect barrier base system of claim 1, wherein the base defines a bottom surface, and further comprising a non-slip footing attached to the bottom surface.

13. The insect barrier base system of claim 1, further comprising a peripheral shield extending downwardly from the tray.

14. The insect barrier base system of claim 13,
wherein the peripheral shield defines a bottom shield edge;
wherein the base defines an upper base edge;
wherein the bottom shield edge and the upper base edge are separated from one another by a distance that is sufficiently small to prevent a feeding animal from accessing the insect-trapping material; and
wherein the distance is also sufficiently large to prevent an insect from bridging the bottom shield edge and the upper base edge.

15. The insect barrier base system of claim 14, wherein the distance ranges from and including 1.25 inches to and including 1.5 inches

16. The insect barrier base system of claim 1, wherein the item is a plant.

17. The insect barrier base system of claim 1, wherein the item is a remnant of a bread product collected at a bottom of a toaster.

18. A method of preventing insect intrusion upon an item, comprising the steps of:
placing the item in a tray, the tray communicating with a top column end of at least one column that communicates at a column bottom end with a base; and
causing an insect to be trapped at a position above the base but before it reaches the tray.

19. The method of claim 18, wherein the step of causing an insect to be trapped comprises the step of exposing an insect trapping material disposed around the at least one column to an ambient environment.

20. The method of claim 19, wherein the step of causing an insect to be trapped further comprises the step of removing an exposed increment of insect trapping material from its position around the at least one column to expose a new increment of insect trapping material to the ambient environment.
